(19) United States
(12) Patent Application Publication
(10) Pub. No.: US 2004/0172988 A1
(43) Pub. Date: Sep. 9, 2004

(54) Security device

(76) Inventor: Alan Jeffrey Gorst, Saddleworth (GB)

Correspondence Address: HARRISON & EGBERT, 412 MAIN STREET, 7TH FLOOR, HOUSTON, TX, 77002, US

(21) Appl. No.: 10/478,911

(22) PCT Filed: Apr. 28, 2003
(86) PCT No.: PCT/GB03/01809

(30) Foreign Application Priority Data
Apr. 15, 2001 (GB) 0209915

(51) Int. Cl. E05B 65/00

(52) U.S. Cl. 70/57.1

(57) ABSTRACT

A security device (20) is provided which comprises a carrier for a tell-tale provision (43) having electromagnetic characteristics. The device (20) is adapted to be releasably secured to an article (10) to be protected, in particular to the shaft (12) of a golf club (10), in a tamper-resilient manner and to retain the tell-tale provision 43) in a spaced relationship from the article (10). In this way any adverse magnetic effects on the tell-tale provision (43) by ferromagnetic parts (12) of the article (10) are avoided. Preferably, the tell-tale provision (43) is spaced at least 3 mm from the article (10) to which the device (20) is secured.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a security device such as may be used to tag articles to provide a protection against theft where such articles are on display for handling by prospective purchasers.

### BACKGROUND OF THE INVENTION

The invention arises from a particular consideration of anti-theft security for golf clubs. Hitherto, known security devices of tell-tale tag type requiring removal were not effective for golf clubs where comfortable trial swings are seen as essential for most golfers considering purchase.

Accordingly, this invention is predicated on the concept of providing a device capable of snug-fitting to an article so as to be unobstructive to handling as desired, such device resisting all but authorized removal.

### BRIEF SUMMARY OF THE INVENTION

According to the present invention there is provided a security device comprising a carrier for a tell-tale provision having electromagnetic characteristics, the device being capable of being releasably secured to an article to be protected in a tamper-resilient manner, and characterized in that the carrier is adapted to retain the tell-tale provision in a spaced relationship from the article such that any adverse magnetic effects on the tell-tale provision by ferromagnetic parts of the article are avoided.

Preferably, the tell-tale provision is spaced at least 3 mm from an article to which the device is secured.

Preferably also, the carrier retains the tell-tale provision in a position such that it is also spaced from any adverse magnetic effects arising from proximity to another article external to the device.

Shielding is preferably also provided to further protect the tell-tale provision from any adverse magnetic effects by ferromagnetic parts of the article.

Advantageously, the device comprises two inter-engaging body parts that can be releasably secured to one another around the or part of the article, preferably by being hinged together to close around and clasp a part of the article to be protected.

Preferably also, each of the body parts defines a half-cylindrical sleeve that together define a cylindrical sleeve that fits about a cylindrical portion of the article when the body parts are secured together.

Preferably also, the half-sleeves are provided with cushioning compliance in order that the device can be snug-fitted to articles in a range of sizes.

It is also an advantage if the interior edge parts of the half-cylindrical sleeves define recesses that create weak or break points so that the edge parts will break off before the body parts can be prised open by levering down the cylindrical sleeve.

Preferably also, the inter-engaging body parts can only be released by means of a tool or a key.

Preferably also, the inter-engaging body parts resiliently engage with one another in a snap-fit manner.

Preferably also, each body part comprises at least two integral projections shaped such that they resiliently inter-engage respectively with complimentary projections provided on the other body part.

Preferably also, each of the projections of one body part defines an outwardly extending tooth that snap-fits around a similar tooth defined by its complimentary projection of the other body part. Three sets of snap-fitting teeth are preferably provided in an orthogonal arrangement.

Preferably also, each of the projections of one body part is provided with a projecting rib that can itself be engaged by a prong of an opening tool that can be inserted through a hole provided in a face of the other body part.

Preferably also, the prong acts on the projecting rib to cause a resilient deflection of the projection sufficient to enable the tooth defined by the projection to be disengaged from the tooth of the complimentary projection of the other body part.

Preferably also, the edges of the body parts 21 and 22 are provided with rib and groove formations 38 and 39 respectively in complementary matching relation to inter-engage on closure of the body parts 21 and 22.

Advantageously, the rib and groove formations define a labyrinthine pathway therebetween. Such an arrangement frustrates attempts to lever the two body parts apart.

As applicable to golf clubs, a device in accordance with the present invention may fit snugly about a golf club shaft at a localized position between its head and grip, preferably with a locating action that is tolerant of a range of shaft diameters, say with compliant gripping.

### BRIEF DESCRIPTION OF THE SEVERAL VIEWS OF THE DRAWINGS

The present invention will now be described by way of example with reference to the accompanying drawings, in which:—

FIGS. 1 and 1a are perspective and detail views of a golf club fitted with a first embodiment of security device in accordance with the invention.

FIG. 2 is a perspective view, to an enlarged scale, of the security device when closed and with a cover plate removed in proximity to a tool for use in opening the device.

FIG. 3 is a side view of the device shown in FIG. 2.

FIG. 4 is an front view of the device shown in FIG. 3 in the direction of arrow IV.

FIGS. 5 and 6 are perspective views from slightly different direction of the device when opened to reveal interior detail thereof.

FIG. 7 is a cross-sectional view along the line VII-VII in FIG. 4.

FIG. 8 is a cross-sectional view along the line VIII-VIII in FIG. 3.

FIGS. 9 and 10 are transverse cross-sectional views along the lines IX-IX and X-X in FIG. 4.

FIG. 11 is a perspective view of a modified security device in accordance with the invention, shown in a closed position; and

FIG. 12 is a cross-sectional view along the line XII-XII in FIG. 3.

### DETAILED DESCRIPTION OF THE INVENTION

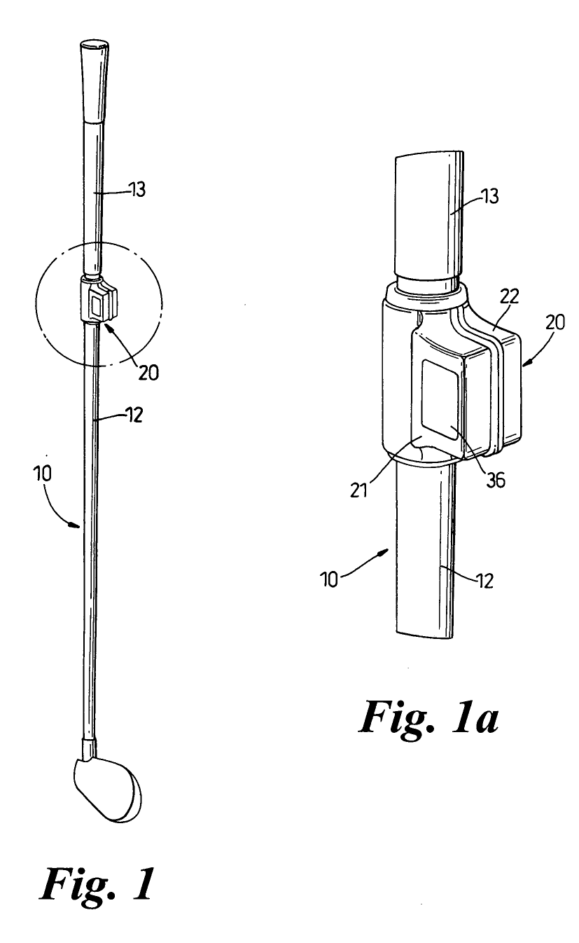

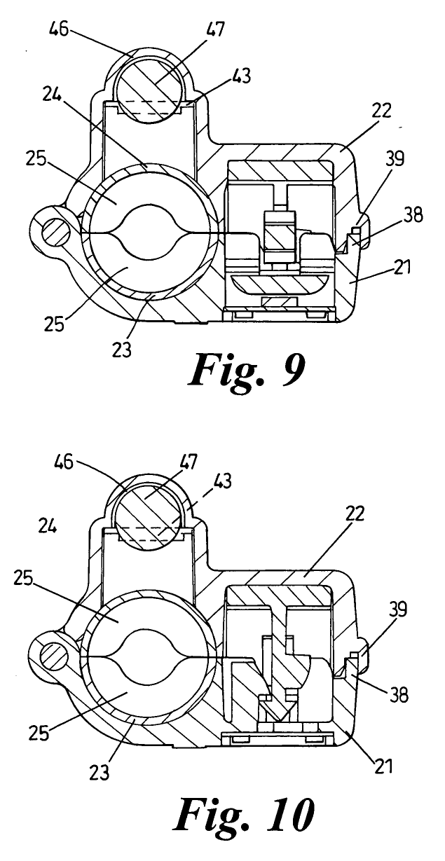

As shown in FIG. 1, a security device 20 according to the invention is particularly adapted for fitment at a localized position of a shaft 12 of a golf club 10, just below a grip 13 at the top of the shaft 12. The device 20 has two body parts 21, 22 respectively defining resilient half-cylindrical sleeves 23, 24 that form an cylindrical sleeve that fits snugly about the shaft 12, preferably with compliant gripping, such as cushioning. The cushioning can be provided by rubber or foam cushions 25 that fit into recesses defined in the sleeves 23, 24, as shown in FIGS. 9 and 10. However, the cushions 25 have been omitted from the other figures for the sake of clarity. Preferably, the body parts 21 and 22 are each integrally formed by moulding from a suitable resilient material, for example polypropylene, nylon, and acetyl plastics materials.

In the illustrated embodiment, the body parts 21, 22 are hinged together by a hinge pin 26 that passes through intercalating hinge-lug formations 27. It should be appreciated, that the hinge between the parts 21 and 33 may be formed in many other ways, for example the two parts can be integrally formed in an integrated clam-shell moulding with a integral hinge formation formed by a thinning of the constituent material as suited to such moulding. It is important, however, that regardless of the particular form of construction that the hinge is resistant to tampering and cannot be easily broken apart.

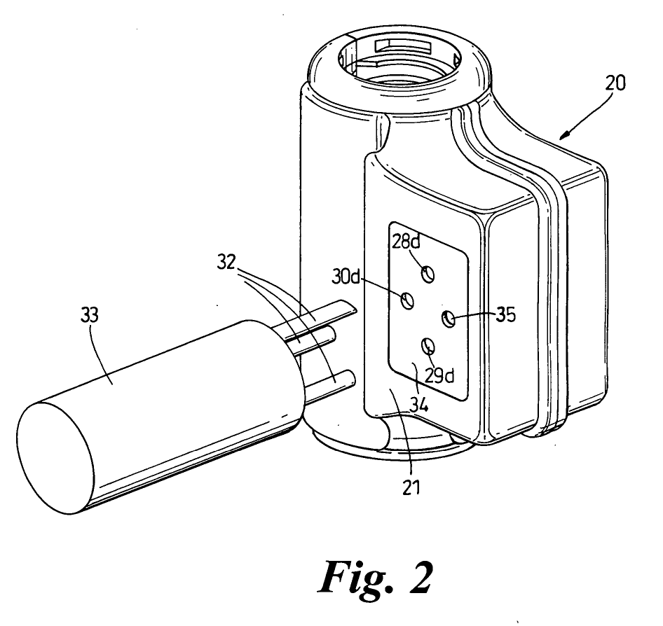

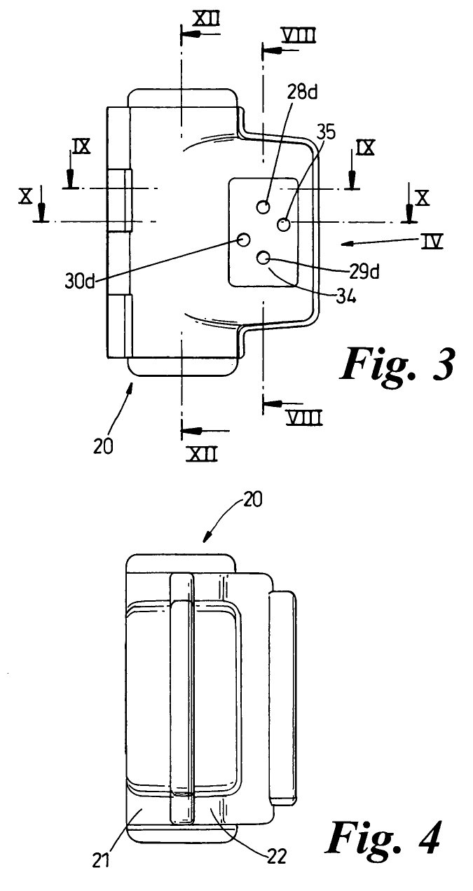

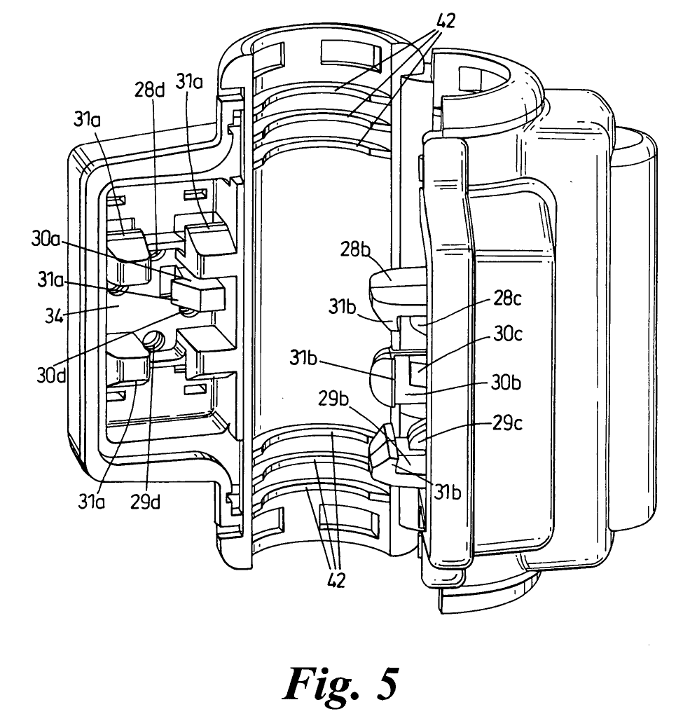

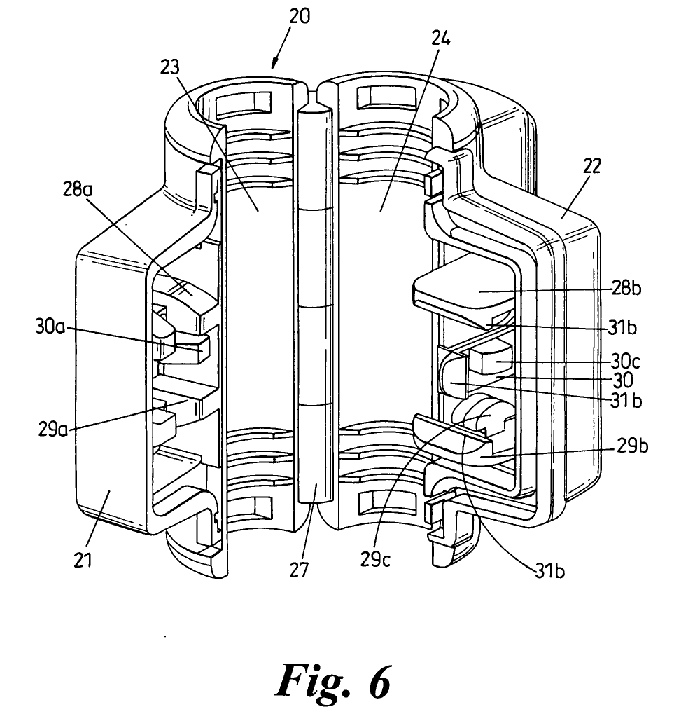

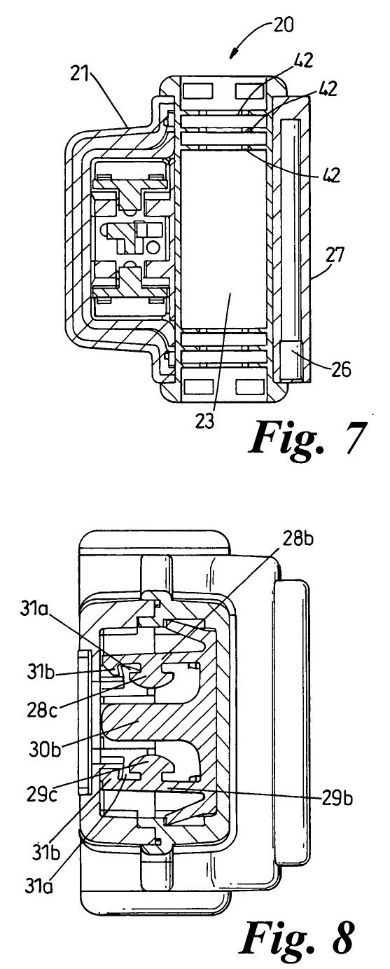

In a box portion adjoining the sleeve 24, the body part 21 is provided with three integral internal toothed projections 28a, 29a, 30a that resiliently inter-engage respectively with complimentary integral internal toothed projections 28b, 29b, 30b provided on the other body part 22. Preferably, the pairs of inter-engaging projections are arranged such that they inter-engage orthogonally. In the present example, each of the projections 28a 29a and 30a has outwardly extending teeth 31a that snap-fit around teeth 31b provided on the projections 28b, 29b, 30b of the part 22 when the parts 21 and 22 are pressed together. In addition, each of the projections 28b, 29b, 30b is provided with a projecting mushroom-section rib 28c, 29c, 30c respectively. When the teeth 31a and 31b are inter-engaged, the ribs 28c and 29c locate between recesses formed respectively in the projections 28a and 29a. The ribs 28c, 29c, and 30c project outwardly from the inter-engaged projections and can themselves be engaged by one of three prongs 32 provided on a special opening tool 33 (see FIG. 2) that are spaced so that they can be inserted through respectively through holes 28d, 29d, and 30d provided in an extension side face 34 of the body part 21. The prongs 32 act on the convex heads of the mushroom-shaped ribs 28c, 29c, and 30c 28c and resiliently deflect the projections 28b, 29b, 30b sufficiently to enable the teeth 31a and 31b to be disengaged from one another in order that the body parts 21 and 22 can be hinged open.

It will be appreciated that this arrangement of resiliently inter-engaging parts which lock the body parts 21 and 22 together is simply one of many arrangements which could be adopted. However, it is important that any arrangement adopted can only be disengaged using a specially designed tool or key to prevent readily available tools such as screwdrivers and the like being used illegally to remove the device 20 from the article 10. Similarly, it is advantageous that at least two, and preferably three orthogonally arranged, sets of inter-engaging formations are provided in order to make their disengagement difficult and thereby to deter tampering.

Another hole or holes 35 in the same side face 34 serve in securing a cover plate 36 by an interference fitting integral peg or pegs (not shown). This serves to hide the entry points for the tool or key as an additional deterrence against tampering.

The edges of the body parts 21 and 22 are provided with rib and groove formations 38 and 39 respectively in complementary matching relation to inter-engage on closure of the body parts 21 and 22. As shown in FIGS. 9 and 10, the overlapping mouldings forming the rib and groove formations 38, 39 define a labyrinthine pathway therebetween that deflects any probing tools that may be used in an attempt to prise the parts 21 and 22 apart.

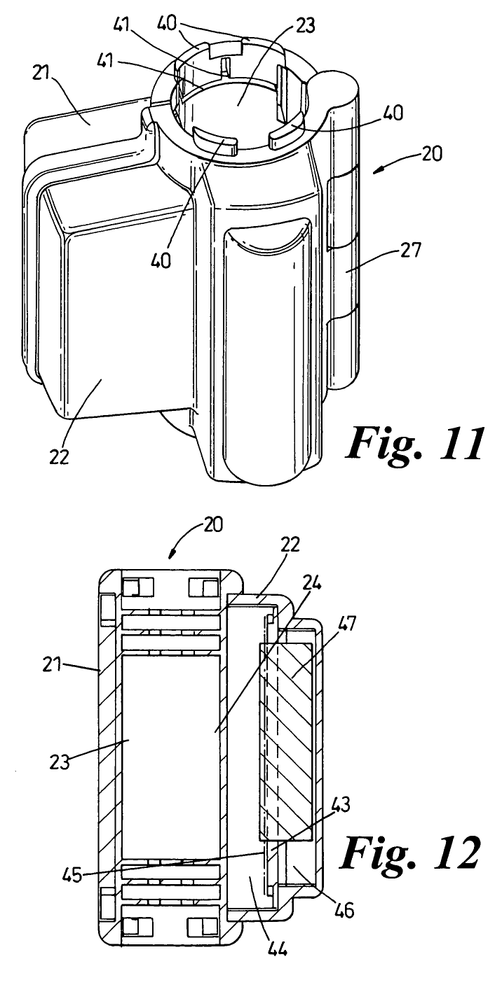

In a modified embodiment, as shown in FIG. 11, the edges of the sleeves 23, 24 are provided with castellations 40 and recesses 41 that create weak or break points. This means that if a tool such as a screwdriver or similar is pushed down the cylindrical sleeve defined by the sleeves 23, 24 when the device is attached to a golf club in an attempt to lever the parts 21 and 22 apart, the castellations 40 and edge parts of the sleeves 23 and 24 will break off before the parts 21 and 22 can be prised open.

The sleeves 23 and 24 are provided with locating engagement with compliant gripping to a range of shaft diameters by way of deformable internal ribs 42 located in spaced relation towards each end of each sleeve 23 and 24. These may be provided in addition to the cushions 25. Alternatively, both the ribs 42 and the cushions 25 could be replaced by pre-formed rubber mouldings (not shown) or by self-adhesive foam pads (not shown) fixed within the sleeves 23, 24.

As shown particularly in FIG. 12, a tell-tale provision is provided by means of a planar member 43 having electromagnetic characteristics that can be sensed at exit from premises if the device 20 has not been removed from the article to which it has been attached. The member 43 is located internally of the device 20 in a chamber 44 provided in the body part 22. The chamber 44 is provided with grooves or other means for the location of the member 43 in a spaced relationship from the article, typically a golf club shaft 12 that passes through the cylinder defined by the half-sleeves 23,24. Preferably, the size of the chamber 44 and the position of the member 43 is such that the latter can be located at least 3 mm and preferably at least 5 mm away from the article in order that any adverse magnetic effects on the tell-tale provision by ferromagnetic parts of the article, such as the shaft 12 itself, are avoided. In addition, a shielding material 45 covering one side of the member 43 may also be interposed between the part of article, i.e. the shaft 12, passing through the sleeves 23 and 24 and the tell-tale provision 43 in order to block adverse magnetic effects from the shaft 12. It will also be appreciated that the provision 43 is located within the chamber 44 such that it is also spaced from any ferromagnetic articles exterior to the device 20 that could be pressed against the device with a view to fooling a sensor for detecting the presence of the device 20.

The chamber 44 may also define an additional semi-cylindrical void 46 at one side which can be used to accommodate other conventional devices or tags 47, such as an RF device or similar.

I claim:

1. A security device (20) comprising a carrier for a tell-tale provision (43) having electro-magnetic characteristics, the device being capable of being releasably secured to an article (10) to be protected in a tamper-resilient manner, and characterized in that the carrier is adapted to retain the tell-tale provision (43) in a spaced relationship from the article (10) such that any adverse magnetic effects on the tell-tale provision by ferromagnetic parts (12) of the article (10) are avoided.

2. A device (20) as claimed in claim 2, characterized in that the tell-tale provision (43) is spaced at least 3 mm from an article (12) to which the device (20) is secured.

3. A device (20) as claimed in claim 1 or claim 2, characterized in that the carrier retains the tell-tale provision (43) in a position such that it is also spaced from any adverse magnetic effects arising from proximity to another article external to the device (20).

4. A device (20) as claimed in any of claims 1 to 3, characterized in that the tell-tale provision (43) is provided with shielding (45) to further protect it from any adverse magnetic effects by ferromagnetic parts (12) of the article (10).

5. A device (20) as claimed in any of claims 1 to 4, characterized in that it comprises two inter-engaging body parts (21, 22) that can be releasably secured to one another around the or part (12) of the article (10).

6. A device as claimed in claim 5, characterized in that the body parts (21, 22) are hinged together to close around and clasp a part (12) of the article (10) to be protected.

7. A device (20) as claimed in claim 5 or claim 6, characterized in that each of the body parts (21, 22) defines a half-cylindrical sleeve (23, 24) that together define a cylindrical sleeve that fits about a cylindrical portion (12) of the article (10) when the body parts (21, 22) are secured together.

8. A device (20) as claimed in claim 7, characterized in that the half-sleeves (23, 24) are provided with compliant gripping (25, 42) in order that the device can be snug-fitted to articles (12) in a range of sizes.

9. A device (20) as claimed in claim 7 or claim 8, characterized in that interior edge parts of the half-cylindrical sleeves (23, 24) define recesses (41) that create weak or break points so that edge parts (40) will break off before the body parts (21, 22) can be prised open by levering down the cylindrical sleeve.

10. A device (20) as claimed in any of claims 5 to 9, characterized in that the inter-engaging body parts (21, 22) can only be released by means of a tool (33) or a key.

11. A device (20) as claimed in any of claims 5 to 10, characterized in that the inter-engaging body parts (21, 22) resiliently engage with one another in a snap-fit manner.

12. A device (20) as claimed in claim 11, characterized in that each body part (21, 22) comprises at least two integral projections (28a, 29a, 30a) shaped such that they resiliently inter-engage respectively with complimentary projections (28b, 29b, 30b) provided on the other body part (22, 21).

13. A device (20) as claimed in claim 12, characterized in that each of the projections (28a, 29a, 30a) of one body part (21) defines an outwardly extending tooth (31a) that snap-fits around a similar tooth (31b) defined by its complimentary projection (28b, 29b, 30b) of the other body part (22).

14. A device (20) as claimed in claim 13, characterized in that three sets of snap-fitting teeth (31a, 31b) are provided in an orthogonal arrangement.

15. A device (20) as claimed in any of claims 12 to 14, characterized in that each of the projections (28b, 29b, 30b) of one body part (22) is provided with a projecting rib (28c, 29c, 30c) that can itself be engaged by a prong (32) of an opening tool (33) that can be inserted through a hole (28d, 29d, 30d) provided in a face (34) of the other body part (21).

16. A device (20) as claimed in claim 15, characterized in that the prong (32) acts on the projecting rib (28c, 29c, 30c) to cause a resilient deflection of the projection (28b, 29b, 30b) sufficient to enable the tooth (31b) defined by the projection (28b, 29b, 30b) to be disengaged from the tooth (31a) of the complimentary projection (28a, 29a, 30a) of the other body part (21).

17. A device (20) as claimed in any of claims 5 to 16, characterized in that the edges of the body parts (21, 22) are provided with rib and groove formations (38,39) respectively in complementary matching relation to inter-engage on closure of the body parts (21, 22).

18. A device as claimed in claim 17, characterized in that the rib and groove formations (38, 39) define a labyrinthine pathway therebetween.
